(19) United States
(12) Patent Application Publication
(10) Pub. No.: US 2007/0237344 A1
(43) Pub. Date: Oct. 11, 2007

(54) Microphone enhancement device

(76) Inventors: Doran Oster, Gainesville, FL (US); Edgar L. Thurmond JR., Gainesville, FL (US)

Correspondence Address: Donald W. Marks, 600 South 29th Road, Arlington, VA, 22202, US

(21) Appl. No.: 11/390,433

(22) Filed: Mar. 28, 2006

(51) Int. Cl. H04R 3/00

(52) U.S. Cl. 381/113; 381/111

(57) ABSTRACT

A microphone enhancing device combines an automatic gain control, a band-limited compressor, and a gate in one very compact package that is small enough and efficient enough to plug into or be wired into the base of almost any microphone. A connector is provided on the device for removably connecting an infrared sensor directed parallel to the microphone. For gooseneck microphones the infrared sensor is also on a gooseneck. Low frequency tones are attenuated irrespective of attenuation of higher tones when a present audio level indicates that a speaker is too close to the microphone; this reduces proximity effect produced by microphones.

### BACKGROUND OF THE INVENTION

The present relates to microphone assemblies such as lectern microphones handheld microphones and other microphones used in pickup of voice sounds for amplification and broadcast to an audience.

Typically the prior art microphones require a speaker to be a set distance close to the microphone. For example if a microphone and audio broadcast system is set to sound good when the speaker's lips are three inches in front of the microphone, then the speech volume heard by the audience will probably weaken when the speaker moves back from microphone.

When the lips of the speaker get very close to the microphone, a different problem occurs in that bass tones appear amplified substantially more than higher tones in the output of the microphone transducer. This is known as the proximity effect. While the proximity effect may enrich the bass tones of a singer, the proximity effect often deteriorates normal speech quality heard by audiences in churches, board rooms or lecture halls.

Often a plurality of microphones are employed in a public audio broadcast system. As the number of open microphones increases, the likelihood of undesirable feedback amplification increases. Prior art systems sometimes include mixers or gates, known as noise gates, that can be programmed to automatically attenuate or mute all microphones except for one microphone picking up speech. The noise gates are not always reliable. For example, the sound of a choir in a church can produce enough background noise to open the gate of a microphone at the wrong time.

One prior art alternative to the sound activated gating of microphone inputs is the employment of proximity sensors, such as infrared or ultrasonic sensors, detecting the presence or absence of a person adjacent the microphone to open or close the microphone. These prior art sensors have been built into the microphone housing or attached to a lectern to operate gates opening or closing the signal lines to the microphone. Incorporating sensors into the microphone housing is expensive and risks compromising the microphone acoustics as well as causing undesirable signal induction. Sensors mounted on a lectern can be covered by papers, books or other objects on the lectern preventing proper operation of the microphone.

Amplification systems which receive the outputs of the microphones and drive speakers broadcasting sound to audiences often include advanced audio processors which can be programmed to improve the quality of the audio broadcast to an audience. For example, automatic gain control (AGC) can be employed to maintain the level of sound broadcast to the audience. However these systems are often expensive, difficult to wire and program, and occupy a cabinet or rack requiring significant space in a room.

### BRIEF SUMMARY OF THE INVENTION

The present invention contemplates a compact package or device which can be incorporated in the line from a microphone. In one embodiment the device is a unit having connectors at opposite ends for simply being plugged in series between the connector on a microphone and its mating connector on a lectern or cable. Alternatively the device can be connected or wired into the line within a lectern or anywhere prior to connection to the amplification system.

In a first aspect the present invention is summarized in a microphone enhancing device for incorporation in a line from a transducer which converts audio sound into an electric signal wherein the device includes means for dividing the electric signal into a low band signal and a high band signal. A signal processor detects a signal level above a threshold level and in response reduces the magnitude of the low band signal irrespective of any reduction in the magnitude of the high band signal. A mixer recombines the reduced low band signal and the high band signal to produce a microphone output signal. It is discovered that this reduction of the level of bass tones reduces the proximity effect improving the quality of speech broadcast to an audience.

When electronics such as signal processors are employed in the microphone enhancing device, the device can easily include automatic gain control for the electric signal when the electric signal is below the threshold.

In a second aspect the present invention is summarized in a microphone enhancing device on which is mounted a flexible gooseneck supporting an infrared sensor on its distal end. The microphone enhancing device can be incorporated in a line from an audio transducer supported by another flexible gooseneck on a support. In the absence of detection of the presence of a person adjacent the microphone, the electric audio signal is muted or attenuated by the microphone enhancing device. Having the infrared sensor mounted on a separate gooseneck provides improved sensing of a person adjacent the microphone along with reducing the chance of the infrared sensor being covered by papers on a lectern. Additionally the mounting of the infrared sensor on a gooseneck enables the infrared sensor to be positioned to receive infrared from different directions.

In a third aspect of the invention, a microphone enhancing device incorporates connectors on opposite ends of an elongated housing for being plugged between a microphone and a cable. An infrared sensor is mounted on a third connector which mates with a fourth connector in the housing so that the infrared sensor can be plugged and unplugged to the device. Circuitry within the device mutes signals from the microphone when the signals from the sensor indicate the absence of a person adjacent the microphone.

Other objects, advantages and features of the invention will be apparent from the following detailed description of the invention taken in conjunction with the accompanying drawings

### BRIEF DESCRIPTION OF THE DRAWINGS

FIG. 1 is a perspective view of one embodiment of a microphone enhancing device in accordance with the invention wherein this particular embodiment is incorporated in a line from a microphone mounted on a lectern.

FIG. 2 is a perspective view of the microphone enhancing device disconnected from the lectern of FIG. 1.

FIG. 3 is a perspective view of the microphone enhancing device of FIG. 2 with a cover removed.

FIG. 4 is a perspective view of a gooseneck supporting a infrared sensor disconnected from FIG. 1.

FIG. 5 is a block diagram of circuitry in the microphone enhancing device.

FIG. 6 is a step diagram of procedure performed by processors in the circuitry of FIG. 5.

FIG. 7 is a perspective view of a modified microphone system with enhancement in accordance with the invention.

### DETAILED DESCRIPTION OF THE INVENTION

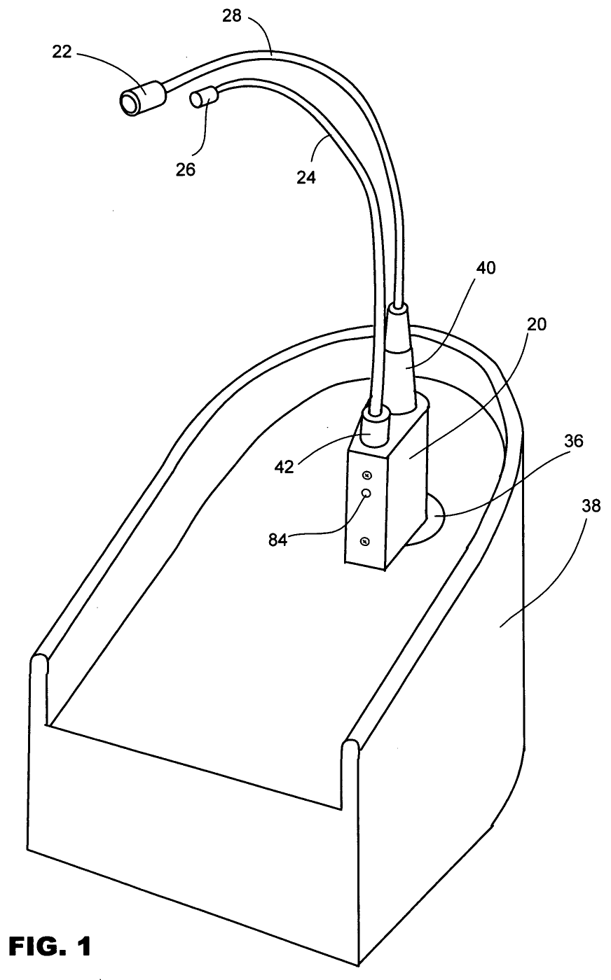

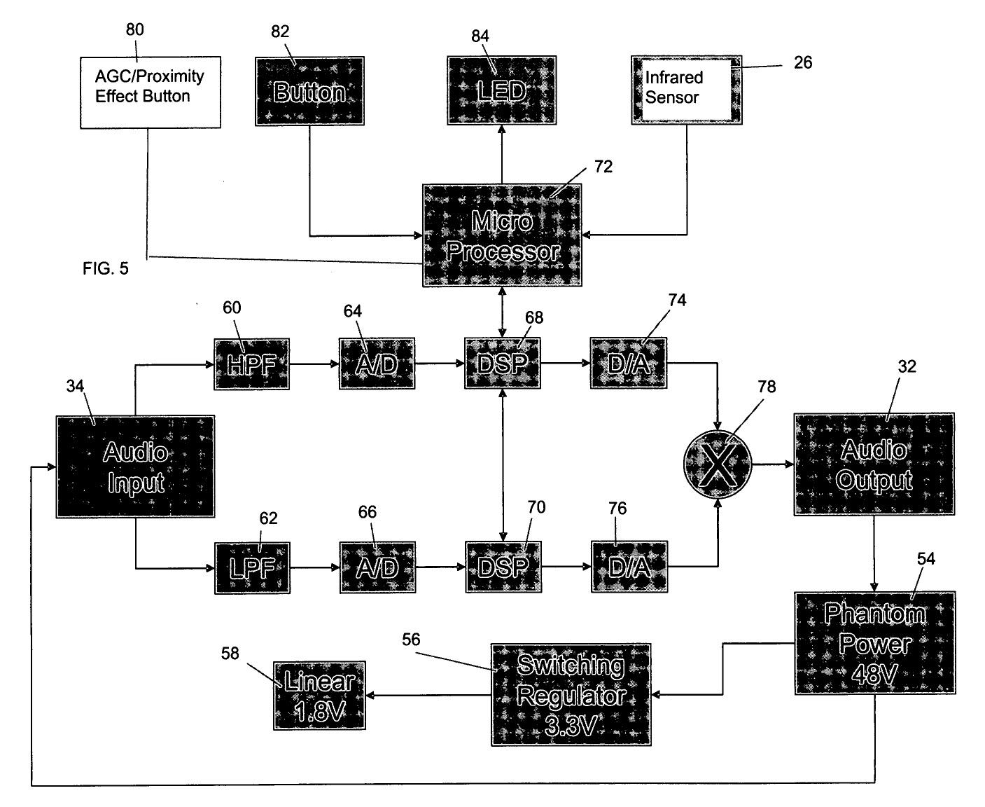

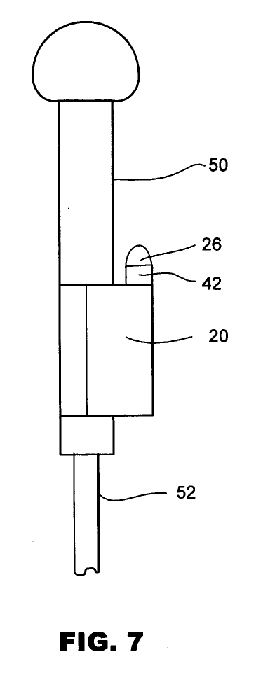

As shown in FIG. 1, a microphone enhancing device 20 in accordance with one embodiment of the invention is connected in series with a line from a transducer or microphone 22 which converts sound from a speaker using the microphone into an electric signal. In accordance with a first aspect of the invention, the device 20 includes circuitry such as shown in FIG. 5 which divides the electric signal from the microphone into a high band signal and a low band signal and reduces the magnitude of the low band signal when a detected signal level exceeds a threshold; thus the device reduces proximity effect in the microphone output. In accordance with a second aspect of the invention, a gooseneck 24 mounted on the device 20 supports an infrared sensor 26 which detects the presence of a person, and in the absence of a person being sensed, the device 20 mutes a signal from the transducer which is mounted on a gooseneck 28; mounting the infrared sensor on the distal end of a gooseneck provides improved exposure of the sensor to radiation and more accurate detection of a person adjacent the microphone to open the microphone. In a variation of the second aspect of the invention suitable for use with a handheld microphone 50 (FIG. 7) plugged directly into the device 20, the infrared gooseneck is replaced by an infrared sensor 26 directed parallel to the handheld microphone to sense the presence of a person using the microphone by sensing infrared radiation from a hand or face in case the microphone 50 is held by a stand (not shown).

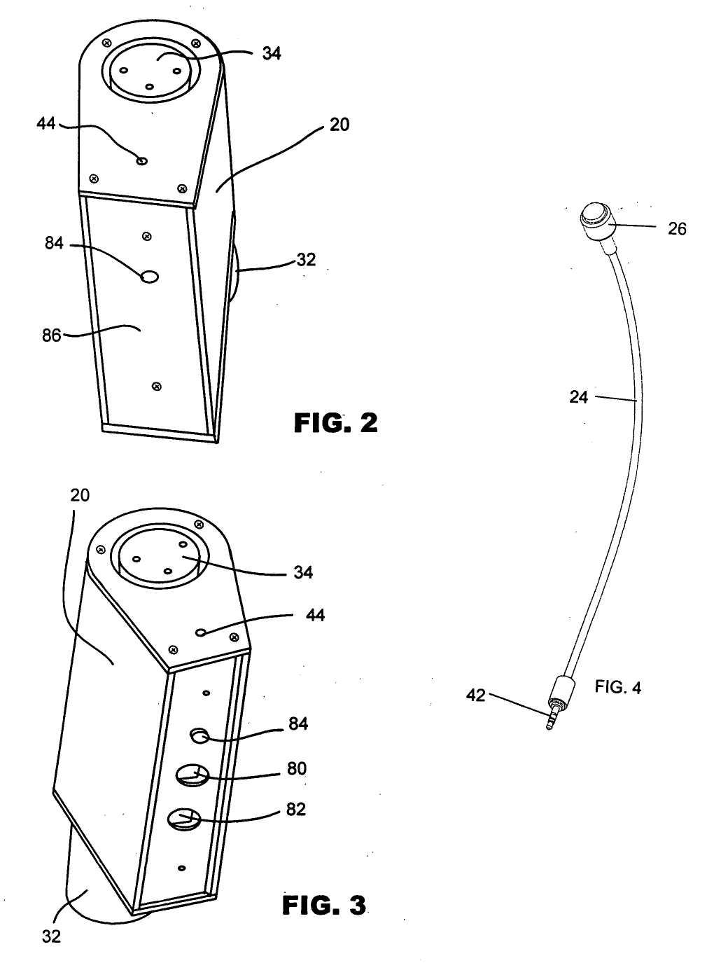

Referring to FIGS. 2 and 3, the device 20 has an elongated housing with connectors, such as a standard male XLR connector 32 and a standard female XLR connector 34, on opposite ends so that the device 20 can be plugged into a mating female connector 36 on a lectern 38 and so that the male connector 40 on a standard gooseneck microphone can be plugged into the device 20. The infrared gooseneck 24, FIG. 4, includes a connector, such as a mini-stereo plug 42, for mating with a connector, such as a mini-stereo jack 44 in the device 20. Preferably the connectors 34 and 44 are on the same end of the device 20 so that both goosenecks 24 and 28 extend parallel in the same direction from the device 20. The microphone 22 is typically a capacitive

In the variation of the microphone system shown in FIG. 7, the device 20 is connected between a handheld microphone 50 and its cable 52. The infrared sensor 26 is mounted directly on the plug 42 for sensing the presence of a person holding the microphone or a person adjacent the handheld microphone in a stand. Alternatively an infrared sensor (not shown) could be mounted directly on the device 20 eliminating the plug 42.

In a still further variation (not shown) of the microphone system, the device 20 can be made without connectors for being wired directly into the microphone lines within a lectern and for being wired to a phone jack (not shown) mounted in the lectern for receiving the infrared sensor plug 42.

The circuitry in the device 20 is shown in FIG. 5 and is powered by phantom power, such as 48 volts, supplied to the balanced audio lines connected to the output connector 32. A phantom power bypass circuit 54 passes the phantom power to the audio lines in the input connector 34 while blocking the audio signal received at input connector 34 on the lines from the microphone transducer from passing to the output connector 32. Voltage regulator circuits 56 and 58 receive power from the circuit 54 to supply suitable voltages to operate the circuitry in the unit 20. The audio input from the microphone received at connector 34 is divided by a high pass filter 60 and a low pass filter 62 into a high band signal and low band signal; in one preferred embodiment the crossover frequency between the high and low band signals is 450 Hz but this crossover frequency is not found to be critical. The high and low band signals are converted into digital signals by respective analog to digital converters 64 and 66. The digital high band signals and low band signals are then applied to respective digital signal processors 68 and 70 connected to a microprocessor 72. After processing, the digital high and low band audio signals from the digital signal processors 68 and 70 are applied to respective digital to analog converters 74 and 76 for being converted back into analog audio signals which are then combined by mixer 78. The combined signal is applied to the lines of the output connector 32. An AGC/proximity effect button switch 80 and a sensing button switch 82 are connected to the microprocessor 72. An LED 84 is operated by the microprocessor 72 to indicate a muted condition of the microphone. Also the sensor 26 is connected to the microprocessor 72.

A cover 86, FIG. 2, is removed in the view of FIG. 3 exposing openings permitting access to the push buttons 80 and 82.

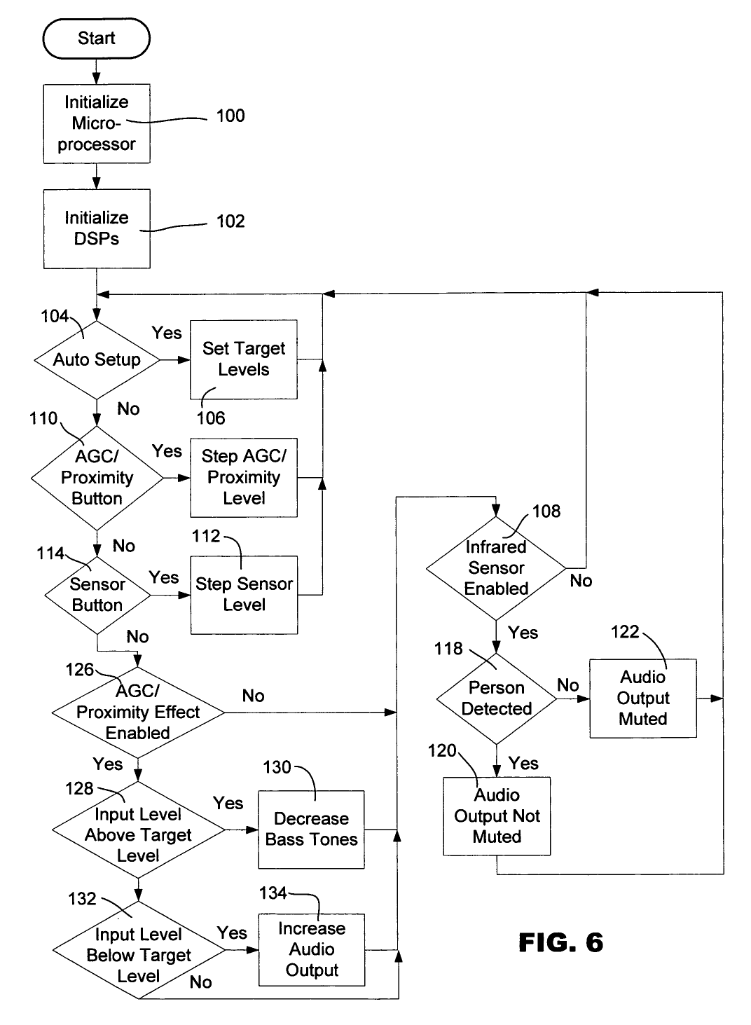

Referring to FIG. 6, the program operating the device 20 initializes the microprocessor in step 100 and the digital signal processors in step 102. At step 104, it is determined if both of the buttons 80 and 82 are depressed and if true, procedure 106 is employed for setting a threshold. During the threshold setting, a speaker at a distance of about ten to twelve inches (25 to 30 centimeters) speaks with a normal voice into the microphone while the LED 84 is flashing. When completed, an absolute average audio level of the high and low audio bands is computed and stored as a threshold. From the procedure 106 the program proceeds to step 108 where it is determined if the infrared proximity sensing (bass proximity effect correction) is enabled. Initially it is not enabled so the program cycles back to step 104.

When step 104 is false the program proceeds to step 110 where it is determined if the AGC/proximity effect button 80 is depressed. If true the program in procedure 112 changes an enable/disable status or limits for automatic gain control and proximity effect correction. Initially the limits are set at zero for no automatic gain control and no proximity correction. A first depression of button 80 sets the automatic gain limit to +6 dB and the proximity effect limit to −12 dB, and a second depression sets the automatic gain limit to +9 dB and leaves the proximity effect limit at −12 dB. A third depression of button 80 returns the limits to zero to disable automatic gain control and proximity effect correction. The number of selectable limits for automatic gain control and/or for proximity correction can be increased to thus increase the number of depressions required to step through the possible selections and back to zero. From the procedure 112, the program cycles back to step 104 through step 108.

When both steps 104 and 110 are false, the program in step 114 determines if the sensing button 82 is depressed. If true, procedure 116 sets a sensitivity level for detecting presence of a person adjacent the microphone. A first depression selects a first sensitivity, a second depression selects a second sensitivity, and a third depression returns the sensitivity to zero to disable the detection of the presence of a person. Additional sensitivities may be programmed to increase the number of depressions required to step through the range of sensitivities and back to zero. With infrared sensing enabled (one of the sensitivities selected), step 108 is true and branches to step 118 which determines whether or not the infrared radiation impinging on the sensor 26 indicates a person is adjacent the microphone based upon the sensitivity selected in procedure 1 16. If true, step 118 branches to procedure 120 where muting of the audio signal is turned off, and if false, step 118 branches to procedure 122 where the audio signal is muted by having the digital signal processors 68 and 70 attenuate or eliminate the audio signals. The ability to select different sensitivities enables microphone gating to be set for speakers at different distances from the microphone; in some circumstances it may be desirable to set gating at a relatively close position while in other circumstances the gating can be set to occur at a relatively far distance.

With neither of the buttons 80 and 82 depressed, the program proceeds to step 126 where it is determined if AGC/proximity effect correction is enabled. If true the program branches to step 128 where it is determined if the present absolute average audio level is above the previously determined threshold level. If true, the program in procedure 130 causes the digital signal processor 70 to attenuate the lower frequency band proportionally to the amount that the present average audio level exceeds the threshold level up to limit (−12 dB) set by the procedure 112. It is noted that the attenuation of the low frequency band is performed without any attenuation or irrespective or any attenuation of the high frequency band; the high frequency band can be attenuated by a small amount to keep the present absolute average audio level close to the threshold. It is found that this attenuation of the low frequency band irrespective of attenuation of the high frequency band reduces the proximity effect (the bass tones appearing to be amplified substantially more than the higher tones) when the speaker's lips are very close to the microphone.

When the present absolute average audio level is below the threshold level, step 132 branches to procedure 134 where the audio levels of both the low level and high level bands are increased proportionally to the amount that the absolute average audio level is below the threshold level. The amount of gain or increase is limited by the limit selected in procedure 112 (+6 dB or +9 dB). Thus when the speaker moves back from the microphone and the audio pickup level by the microphone is reduced, the audio output from the enhancement device 20 will tend to reduce or eliminate any drop off in the sound level broadcast to an audience.

The microphone enhancing device 20 combines an automatic gain control, a band-limited compressor, and a gate in one very compact package that is small enough and efficient enough to plug into the base of almost any microphone. It uses very low current components, so that it can be powered with the phantom power that is normally delivered to a microphone from its mixer. This module 20 replaces a large unit with processors in a rack. Since the device 20 does not need a power supply, large case, a complicated user interface, or extensive processing power, an amplification system employing one or more of the devices 20 in series with microphones can be relatively inexpensive. It can be used in churches, lecture halls, and conference rooms eliminating the need of a sound controller to adjust audio levels and gate microphones.

It is intended that the above detailed description of the invention and the accompanying drawings be interpreted as being only illustrative of one or more preferred embodiments and that many modifications, variations and changes in detail can be made to the described embodiments without departing from the scope and spirit of the invention. For example, the described structure has two pushbutton switches, a specific crossover frequency, an absolute average audio level, a −12 dB attenuation limit, and +6 dB and +9 dB automatic gain limits; however three or more switches, other crossover frequencies, measured audio levels, attenuation limits and gain limits can be used and may in some circumstances be found to be better.

1. A microphone enhancing device for incorporation in a line from a transducer which converts audio sound into an electric signal, the device comprising:
means for dividing the electric signal into a low band signal and a high band signal;
a signal processor for detecting a signal level above a threshold level and for reducing the magnitude of the low band signal irrespective of any reduction in the magnitude of the high band signal; and
a mixer for recombining the low band signal and the high band signal to produce a microphone output signal wherein bass proximity effect is reduced.

2. A microphone enhancing device as claimed in claim 1 wherein the detected signal level includes the level of the high band signal.

3. A microphone enhancing device as claimed in claim 1 wherein the detected signal level includes the level of the low band signal.

4. A microphone enhancing device as claimed in claim 1 wherein the reduction of the low band signal is proportional to the increase of the detected signal level above the threshold level.

5. A microphone enhancing device as claimed in claim 4 wherein the reduction of the low band signal is limited to a predetermined reduction limit.

6. A microphone enhancing device as claimed in claim 1 wherein the signal processor detects a signal level below an AGC threshold and increases the high band signal and the low band signal proportional to the decrease of the detected signal level below the AGC threshold.

7. A microphone enhancing device as claimed in claim 5 wherein the signal processor detects a signal level below an AGC threshold and increases the high band signal and the low band signal proportional to the decrease of the detected signal level below the AGC threshold, and the increase in the high band signal and low band signal is limited by a predetermined increase limit.

8. A microphone enhancing device as claimed in claim 7 including user control means for selecting the predetermined increase limit from a plurality of possible increase limits.

9. A microphone enhancing device as claimed in claim 1 wherein the signal processor includes a microprocessor and a digital signal processor controlled by the microprocessor.

10. A microphone enhancing device for incorporation in a line from a transducer supported by a first flexible gooseneck on a support and which converts audio sound into an electric audio signal, the device comprising:
an infrared transducer for converting infrared light into an electric infrared signal;
a second flexible gooseneck supporting and connecting the infrared transducer to the support; and
muting means responsive to the electric infrared signal indicating the absence of a person adjacent the infrared transducer for muting the electric audio signal.

11. A microphone enhancing device as claimed in claim 10 wherein the support includes first and second electrical connectors and the first and second goosenecks include third and fourth electrical connectors for mating with the respective first and second connectors.

12. A microphone enhancing device as claimed in claim 11 wherein the support further includes a fifth electrical connector for connecting the microphone enhancing device to an audio amplifier and broadcast system, and a unit having a sixth electrical connector for mating with the fifth electrical connector; said first and second electrical connectors being included in said unit; and said muting means being contained in said unit.

13. A microphone enhancing device as claimed in claim 12 wherein the unit further includes:
means for dividing the electric signal into a low band signal and a high band signal;
a signal processor for detecting a signal level above a threshold level and for reducing the magnitude of the low band signal irrespective of any reduction in the magnitude of the high band signal; and
a mixer for recombining the low band signal and the high band signal to produce a microphone output signal wherein bass proximity effect is reduced.

14. A microphone enhancing device as claimed in claim 13 wherein the signal processor detects a signal level below an AGC threshold and increases the high band signal and the low band signal proportional to the decrease of the detected signal level below the AGC threshold.

15. A microphone enhancing device as claimed in claim 14 wherein the signal processor detects a signal level below an AGC threshold and increases the high band signal and the low band signal proportional to the decrease of the detected signal level below the AGC threshold, and the increase in the high band signal and low band signal is limited by a predetermined increase limit.

16. A microphone enhancing device for being plugged in series between a microphone and a cable, the device comprising:
an elongated housing;
first and second connectors on opposite ends of the elongated housing for connecting the device at one end to the microphone and at the other end to the cable;
an infrared sensor mounted on a third connector;
a fourth connector mounted on the housing for mating with the third connector so that the infrared sensor is directed parallel to the microphone; and
muting means in the housing connected to the first, second and fourth connectors for responding to a signal from the infrared sensor indicating the presence of a person adjacent the microphone for passing audio signals from the first connector to the second connector and for responding to the signal from the infrared sensor indicating the absence of a person adjacent the microphone for muting audio signals from the first connector to the second connector.

17. A microphone enhancing device as claimed in claim 16 wherein the microphone is a handheld microphone.

18. A microphone enhancing device as claimed in claim 16 wherein the microphone is gooseneck microphone and the infrared sensor includes a gooseneck with the infrared sensor being on the distal end of the gooseneck.
